(19) United States
(12) Patent Application Publication
(10) Pub. No.: US 2013/0106702 A1
(43) Pub. Date: May 2, 2013

(54) PROXIMITY SENSING DEVICE WITH KEYBOARD FUNCTION

(71) Applicant: Yi-Ta Chen, Hsinchu City (TW)

(72) Inventors: Yi-Ta CHEN, Hsinchu City (TW); Min-Feng YEN, Hsinchu City (TW); Chiu-Lin CHIANG, Hsinchu City (TW); Li-Ing CHANG, Hsinchu City (TW); Ming-Hung CHIEN, Hsinchu City (TW); Mao-Chih HUA, Hsinchu City (TW)

(73) Assignee: Yi-Ta CHEN, Hsinchu City (TW)

(21) Appl. No.: 13/664,300

(22) Filed: Oct. 30, 2012

(30) Foreign Application Priority Data
Oct. 31, 2011 (TW) 100220444

(51) Int. Cl. G06F 3/02

(52) U.S. Cl. 345/168

(57) ABSTRACT

A proximity sensing device with a keyboard function is provided, which includes: a substrate, proximity sensing units, a proximity detection circuit, a key unit, and a main control unit. The proximity sensing unit i senses proximity of object and generating a proximity sensing signal. The proximity detection circuit detects the proximity sensing signal generated for the object and calculating output signal according to the proximity sensing signal. The key unit covers the substrate and has key areas. The main control unit receives the output signal output by the proximity detection circuit; when the output signal is one of coordinates corresponding to the key areas and is greater than a set key value, outputting a corresponding key value according to the coordinate corresponding to the key area; and when the output signal is greater than a set touch value, converting the output signal and outputting a touch coordinate.

### CROSS-REFERENCES TO RELATED APPLICATIONS

This non-provisional application claims priority under 35 U.S.C. §119(a) on Patent Application No. 100220444 filed in Taiwan, R.O.C. on 2011/10/31, the entire contents of which are hereby incorporated by reference.

### BACKGROUND OF THE INVENTION

1. Technical Field

The present invention relates to a proximity sensing device, and more particularly to a proximity sensing device with a keyboard function.

2. Related Art

With the development of photoelectric technologies, proximity switching devices have been widely used in different machines such as smart phones, ticketing systems of transport vehicles, digital cameras, remote controls, and liquid crystal screens. Common short-distance control devices include proximity sensors and touch panels, which are mainly used for switching the state of a system.

Currently, touch panels have been widely applied in various different places such as ATMs, iphones, and ipads. Although touch panels have been widely applied in different places, the operation of most touch panels, such as transparent touch panels or touch panels in computers, is limited to a planar operation.

In addition to the planar touch detection, many manufacturers have tried to apply touch technologies in keyboard devices. However, keyboard input is currently implemented through capacitive touch detection technologies. Alternatively, a touch panel is simply made into an input device having a feeling of keys, which substantially loses the touch function and merely has a keyboard function.

Therefore, the keyboard function and the touch detection function cannot be integrated in the prior art. To integrate the keyboard function and the touch detection function, the existing practice is to open an additional touch area in the keyboard area, specially designed for a touch operation of a user. Therefore, the user operates keys when wishing to use the keys, and performs operations on the touch panel when wishing to use the touch function.

If the key function can be implemented at the same time based on the touch function of the touch panel, the user can directly perform keyboard operations and touch at the same time on various keyboards.

### SUMMARY

In view of the problem in the prior art that touch and key functions cannot be implemented at the same time on the touch panel, the present invention provides a proximity sensing device with a keyboard function, which includes: a substrate, a plurality of proximity sensing units, a proximity detection circuit, a key unit, and a main control unit. The proximity sensing unit is formed on the substrate, for sensing proximity of at least one object and generating a proximity sensing signal. The proximity detection circuit is connected to the proximity sensing unit, for detecting the proximity sensing signal generated for at least one object and calculating at least one output signal according to the proximity sensing signal. The key unit covers the substrate and has a plurality of key areas. The main control unit is connected to the proximity detection circuit, for receiving at least one output signal output by the proximity detection circuit; when the output signal is one of coordinates corresponding to the key areas and is greater than a set key value, outputting a corresponding key value according to the coordinate corresponding to the key area; and when the output signal is greater than a set touch value, converting the output signal and outputting a touch coordinate.

The present invention further provides a proximity sensing device with a keyboard function, which includes: a substrate, a plurality of proximity sensing units, a proximity detection circuit, a key unit, and a main control unit. The proximity sensing unit is formed on the substrate, for sensing proximity of at least one object and generating a proximity sensing signal. The proximity detection circuit is connected to the proximity sensing unit, for detecting the proximity sensing signal generated for at least one object and calculating at least one output signal according to the proximity sensing signal. The key unit covers the substrate and has a plurality of key areas. The main control unit is connected to the proximity detection circuit, for receiving at least one output signal output by the proximity detection circuit and switching to a proximity detection mode or a key detection mode according to a switching instruction; in the proximity detection mode, when the output signal is greater than a set touch value or a set hover value, converting at least one output signal and outputting a touch coordinate or a hover coordinate; and in the key detection mode, when the output signal is one of coordinates corresponding to the key areas and is greater than a set key value, outputting a corresponding key value according to the coordinate corresponding to the key area.

Through the present invention, the touch function and the key function can be implemented at the same time through touch panel technologies, thereby achieving the specific effect of reducing the cost and implementing a dual-function.

The detailed features and advantages of the present invention are described below in great detail through the following embodiments, and the content of the detailed description is sufficient for persons skilled in the art to understand the technical content of the present invention and to implement the present invention there accordingly. Based upon the content of the specification, the claims, and the drawings, persons skilled in the art can easily understand the relevant objectives and advantages of the present invention.

### BRIEF DESCRIPTION OF THE DRAWINGS

The present invention will become more fully understood from the detailed description given herein below for illustration only, and thus not limitative of the present invention, wherein:

FIG. 1 shows a proximity sensing device with a keyboard function;

FIG. 2A shows a first embodiment of a proximity sensing device with a keyboard function according to the present invention;

FIG. 2B shows the first embodiment of the proximity sensing device with a keyboard function according to the present invention;

FIG. 2C shows the first embodiment of the proximity sensing device with a keyboard function according to the present invention;

FIG. 3A is a first sectional view of a first example in the first embodiment of the proximity sensing device according to the present invention;

FIG. 3B is a second sectional view of the first example in the first embodiment of the proximity sensing device according to the present invention;

FIG. 3C is a third sectional view of the first example in the first embodiment of the proximity sensing device according to the present invention;

FIG. 3D is a first sectional view of a second example in the first embodiment of the proximity sensing device according to the present invention;

FIG. 4A is a first timing diagram of the first embodiment of the proximity sensing device according to the present invention;

FIG. 4B is a second timing diagram of the first embodiment of the proximity sensing device according to the present invention;

FIG. 4C is a third timing diagram of the first embodiment of the proximity sensing device according to the present invention;

FIG. 5 shows another embodiment of the proximity sensing device with a keyboard function according to the present invention;

FIG. 6A shows a second embodiment of the proximity sensing device with a keyboard function according to the present invention;

FIG. 6B is a sectional view of the second embodiment of the proximity sensing device with a keyboard function according to the present invention;

FIG. 6C is a sectional view of a third embodiment of the proximity sensing device with a keyboard function according to the present invention; and

FIG. 7 shows a fourth embodiment of the proximity sensing device with a keyboard function according to the present invention.

### DETAILED DESCRIPTION

The present invention provides a proximity sensing device with a keyboard function, where proximity sensing units are directly formed on a substrate with various different panels, so that the applied substrate has a proximity sensing function and man-machine interfaces of the panels can be remotely controlled, thereby achieving a desirable man-machine interaction effect.

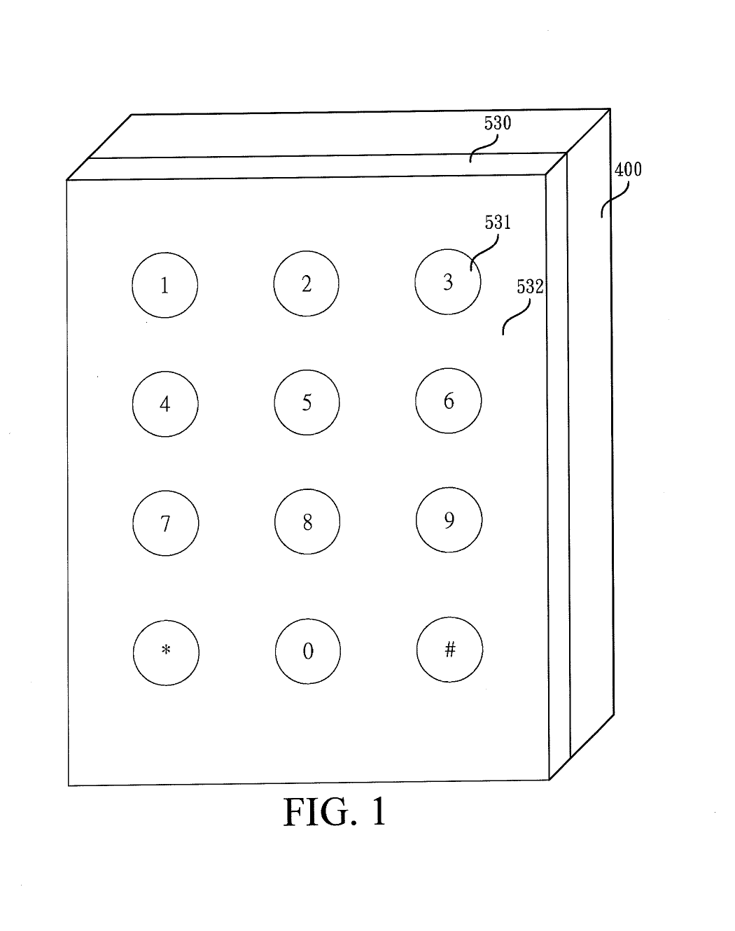

Please refer to FIG. 1, in which a proximity sensing device with a keyboard function is shown. A key unit is formed by a substrate 530, key areas 531, and non-key areas 532. The key unit covers the proximity sensing device. The present invention adopts a combination of such hardware architecture to implement the proximity sensing device with a key function. That is, the proximity sensing device further has a key operation function in addition to a proximity coordinate detection function. In other words, a value of a coordinate where a touch occurs is output, or a specific key value may be output.

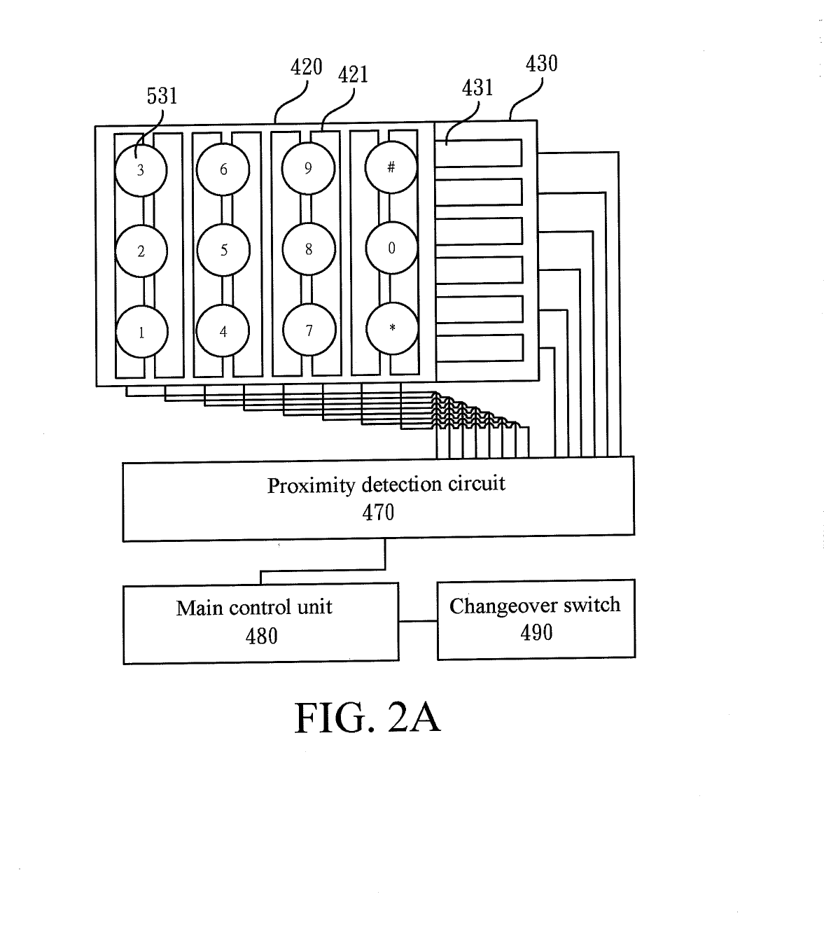

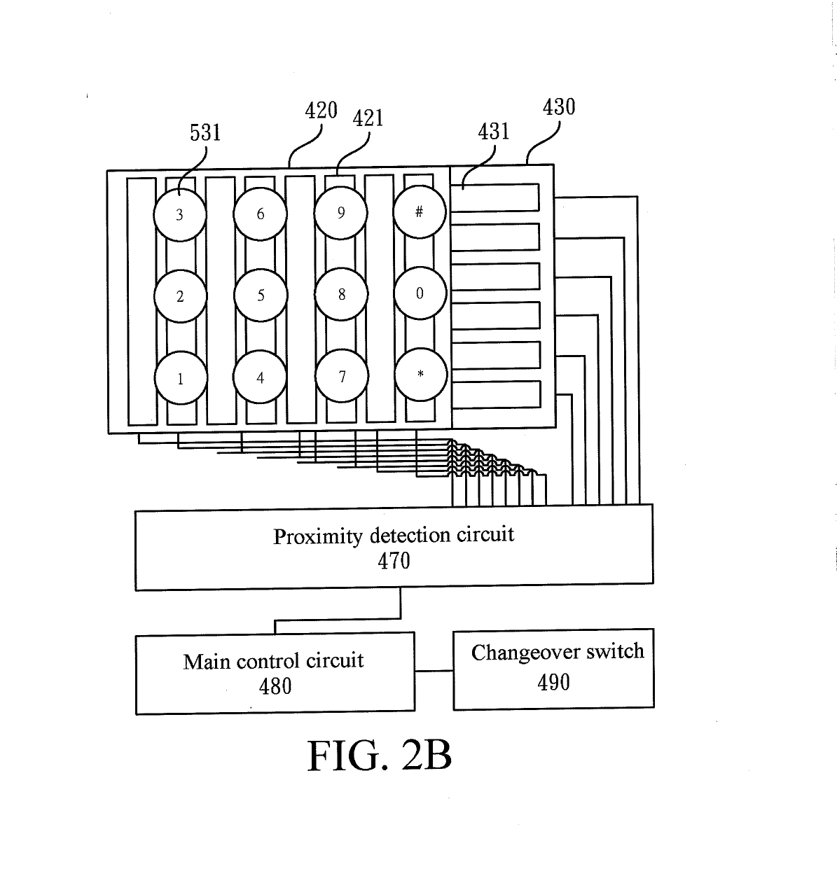

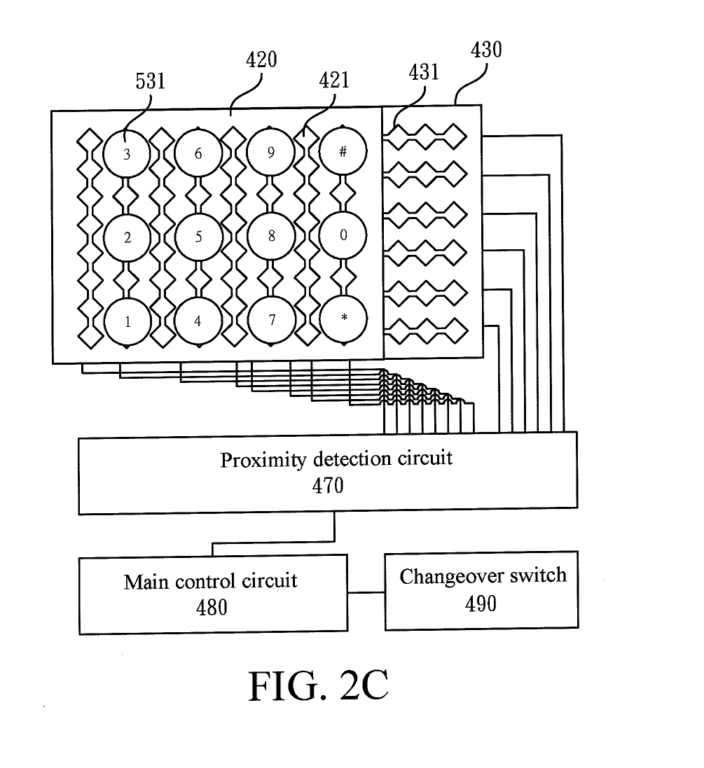

Please refer to FIG. 2A, a block functional diagram of a proximity sensing panel of the present invention. The proximity sensing device with a keyboard function includes: substrates 420 and 430, a plurality of proximity sensing units, a key unit, a proximity detection circuit 470, a main control unit 480, and a changeover switch 490. The proximity sensing unit is formed by a first sensing axis 421 formed on the substrate 420 and a second sensing axis 431 formed on the substrate 430, for sensing proximity of an object and generating a proximity sensing signal. The key unit is formed by a plurality of key areas 531 and a substrate thereof (not shown), and covers the substrate. The proximity detection circuit 470 is connected to the proximity sensing unit, to calculate at least one hover coordinate when the proximity sensing signal of the proximity sensing unit is greater than a hover threshold, and to calculate at least one touch coordinate when the proximity sensing signal of the proximity sensing unit is greater than a touch threshold.

The definition of a threshold varies according to practices of different proximity detection circuits. For example, some proximity detection circuits adopt a positive threshold for definition, and calculate a touch coordinate or a hover coordinate with respect to a maximum, while some proximity detection circuits adopt a negative threshold for definition, and calculate a touch coordinate or a hover coordinate with respect to a minimum. The present invention can adopt both definition manners.

The main control unit 480 is connected to the proximity detection circuit 470. The main control unit 480 has two control manners to implement keyboard detection and proximity detection.

The first control manner is a synchronous detection mode. Ordinarily, when receiving a hover coordinate or a touch coordinate output by the proximity detection circuit 470, the main control unit 480 outputs the hover coordinate or the touch coordinate. When it is detected that a hover coordinate at one of the key areas 531 that is output by the proximity detection circuit 470 is converted into a touch coordinate, it indicates that a user performs a key pressing operation at the key area 531, and the main control unit 480 outputs a corresponding key value according to a coordinate corresponding to the key area 531. Since the key area can be pressed by the user, when the user does not perform pressing; the proximity detection circuit 470 can detect a hover coordinate as the object is in a hover detection range. The conditions of other non-key areas are the same. However, only the part corresponding to the coordinate at the key area 531 can be pressed; that is, when the user presses the key area 531, a detection value is changed to a set key value from a set hover value of the hover coordinate. Therefore, the main control unit 480 can confirm that the user performs a key pressing operation according to the change. At this time, conversion and output of the key value may be performed.

In other words, when no key pressing operation occurs, the proximity detection circuit 470 detects proximity, including operations such as touch and hover, of at least one object. When no key is operated, the hover in key pressing can also be detected at the key area. However, when a key is operated, at the coordinate of the key area, a hover threshold of the point is converted into a key threshold.

Therefore, the proximity detection circuit 470 is actually connected to the proximity sensing unit, and is capable of detecting a proximity sensing signal generated for at least one object and calculating at least one output signal according to the proximity sensing signal. The main control unit 480 is connected to the proximity detection circuit 470, for receiving at least one output signal output by the proximity detection circuit 470; when the output signal is one of the coordinates corresponding to the key areas and is greater than a set key value (a key threshold), outputting a corresponding key value according to the coordinate corresponding to the key area; and when the output signal is greater than a set touch value (a touch threshold or a hover threshold), converting the output signal and outputting a touch coordinate (a touch threshold or a hover threshold).

The second control manner is to perform switching in a proximity detection mode or a key detection mode. That is, the proximity sensing unit is a device for sensing proximity of an object when the object approaches and generating a proximity sensing signal. The present invention adopts a switching mode to respectively switch a proximity detection mode or a key detection mode. When the mode is the proximity detection mode and the user gets close to the proximity sensing unit with a finger, the proximity detection circuit 470 may output a hover coordinate or a touch coordinate to the main control unit 480. When the mode is switched to the key detection mode, the user can perform operations at the key area; and when the user presses a key at the key area, the main control unit 480 outputs a corresponding key value of a coordinate corresponding to the operated key area.

In other words, in a proximity detection mode, when the output signal is greater than a set touch value (a touch threshold or a hover threshold), the main control unit 480 converts the output signal and outputs a touch coordinate (a touch threshold or a hover threshold); in a key detection mode, when the output signal is one of the coordinates corresponding to the key areas and is greater than a set key value (a key threshold), the main control unit 480 outputs a corresponding key value according to the coordinate corresponding to the key area.

By adopting the present invention, in practice, switching to a proximity detection mode or a key detection mode can be performed according to a switching instruction, in the proximity detection mode, a hover coordinate or a touch coordinate is output; and in the key detection mode, a corresponding key value is output according to the coordinate corresponding to the key area.

The switching is performed according to a switching instruction. For example, the switching instruction is generated when the main control unit 480 detects the change of the output signal. That is, when the change of the output signal meets a specific condition, the switching instruction is generated. For example, the switching instruction is a proximity gesture, and the proximity gesture is obtained through calculation by the main control unit 480 according to the change of the hover coordinate or the touch coordinate, which is a specific condition for the change of the output signal. For another example, the specific condition is further defined by taking the proximity gesture as double-click or drawing. For another example, the switching instruction is generated when one of the key areas 531 is operated, that is, a certain key coordinate is used as a soft changeover switch. Therefore, the switching instruction of the soft switching is generated according to the specific change of the output signal.

In addition to the soft switching manner, a hard switching manner also exists. For example, the switching instruction is generated by an external changeover switch.

In the structure of the proximity sensing device, the proximity sensing unit may be formed by a plurality of first sensing axes and a plurality of second sensing axes formed on different layers of the substrate. Alternatively, the proximity sensing unit may be formed by a plurality of first sensing axes formed on the substrate and a plurality of second sensing axes arranged below the substrate. Alternatively, the proximity sensing unit may be formed by a single proximity sensing unit with a single-layer structure (in an embodiment shown in FIG. 7). The substrate may be a rigid board, a flexible board, or a glass substrate.

The proximity sensing unit recognizes the distance according to different magnitudes of sensing signals generated based on the distance from the object to the proximity sensing unit, where the magnitudes of the sensing signals are the capacity change. An oscillation circuit in the proximity detection circuit 470 changes the oscillation frequency/amplitude according to the capacity change, and generates a control signal according to the oscillation frequency/amplitude and outputs the signal to a controller in the proximity detection circuit 470. The proximity sensing unit may adopt a capacitive proximity sensing unit, for example, a self-capacitance proximity sensing unit or a mutual-capacitance proximity sensing unit. The self-capacitance proximity sensing unit uses at least one electrode for driving and sensing. The mutual-capacitance proximity sensing unit uses arrangement of at least two electrodes for driving and sensing respectively.

In the embodiment shown in FIG. 2A, an X-axis sensing electrode (the first sensing axis 421), and a Y-axis sensing electrode (the second sensing axis 431), may be differentiated, which may be respectively implemented through self-capacitance proximity detection technologies or mutual-capacitance proximity detection technologies.

Taking the mutual-capacitance proximity detection as an example, the sensing circuit includes a driving circuit and a detection circuit. The mutual-capacitance proximity sensing unit includes at least two electrodes. A principle of performing object proximity detection through the mutual-capacitance proximity detection technologies is as follows: the driving circuit drives a signal at the Y-axis sensing electrode connected to the driving circuit, and the X-axis sensing electrode generates corresponding mutual-capacitance sensing. When an object gets close to the mutual-capacitance proximity sensing unit, the capacity of the mutual-capacitance proximity sensing unit is changed due to interference. At this time, the detection circuit may detect a capacity change according to the second electrode connected to the detection circuit, and obtain a capacity change of the mutual-capacitance proximity sensing unit according to the change of a voltage or a current. In this way, a relative distance from the object approaching the panel may be calculated. The use of mutual-capacitance proximity detection technologies can achieve an efficacy of rapid response and high reliability.

The key area is arranged at any position above the touch device. FIG. 2B and FIG. 2C show a special case of the arrangement, that is, the key area is disposed at an intersection of the X-axis sensing electrode (the first sensing axis 421), and the Y-axis sensing electrode (the second sensing axis 431). Taking FIG. 2B as an example, the key area 531 is disposed at an intersection of the X-axis sensing electrode (the first sensing axis 421), and the Y-axis sensing electrode (the second sensing axis 431), that are bar-shaped. Taking FIG. 2C as an example, the key area 531 is disposed at an intersection of the X-axis sensing electrode (the first sensing axis 421), and the Y-axis sensing electrode (the second sensing axis 431), that are diamond-shaped.

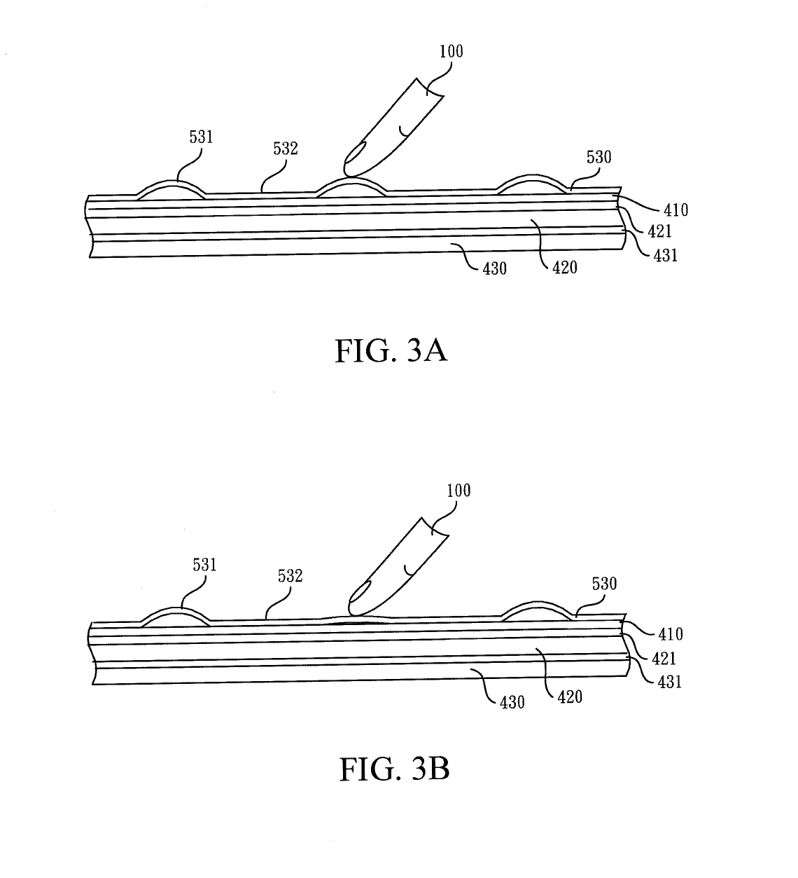

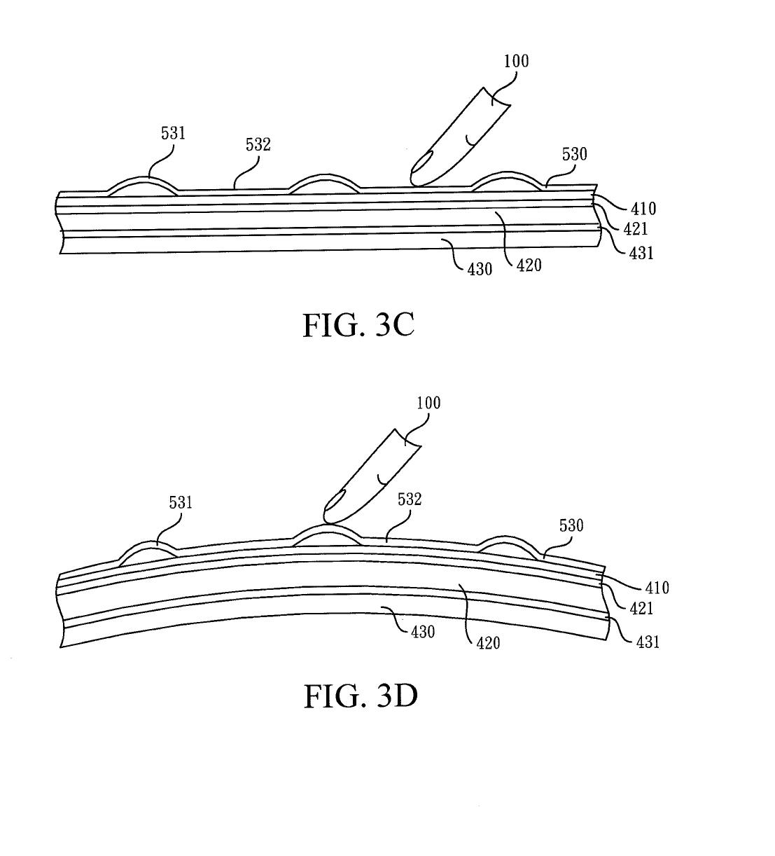

Now please refer to FIG. 3A, which is a sectional view of FIG. 2 showing that the key area is about to be pressed. FIG. 3B is a view showing that the key area is pressed. FIG. 3C is a view showing that the non-key area is touched.

In FIG. 3A, a carrier of the key area 531 is the substrate 530. In this embodiment, a soft plastic material is adopted to fabricate the substrate 530, so that a protruding key area 531 is formed and the key area 531 is deformable. The first sensing axis 421 is carried on the substrate 420, and the second sensing axis 431 is carried on the substrate 430. In practice, an insulating layer 410 is formed on the first sensing axis 431, so as to prevent the first sensing axis 431 from being oxidized.

The substrates 420 and 430 may be made of a polyethylene terephthalate (PET) material. The first sensing axis 421 and the second sensing axis 431 forming the proximity sensing unit may be made of silver paste. If the substrate is made of PET, the substrate may be flexible and fabricated into an irregular surface.

Please refer to FIG. 3D, which is a first sectional view of a second example in the first embodiment of the proximity sensing device according to the present invention. In FIG. 3D, the key unit is formed by key areas 531 and non-key areas 532, and the key areas 531 and the non-key areas 532 form a structure with an irregular surface. The substrates 420 and 430 are flexible boards, and the flexible board is disposed corresponding to the irregular surface of the key unit, so that a spacing between the key unit and the flexible board is fixed. In this way, the inductance of hover detection or touch detection can be consistent with each other.

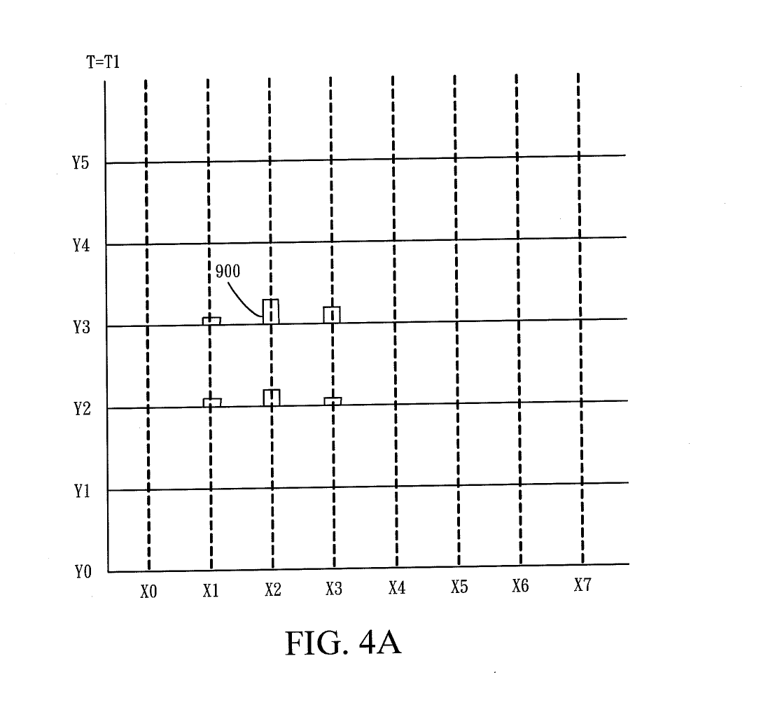

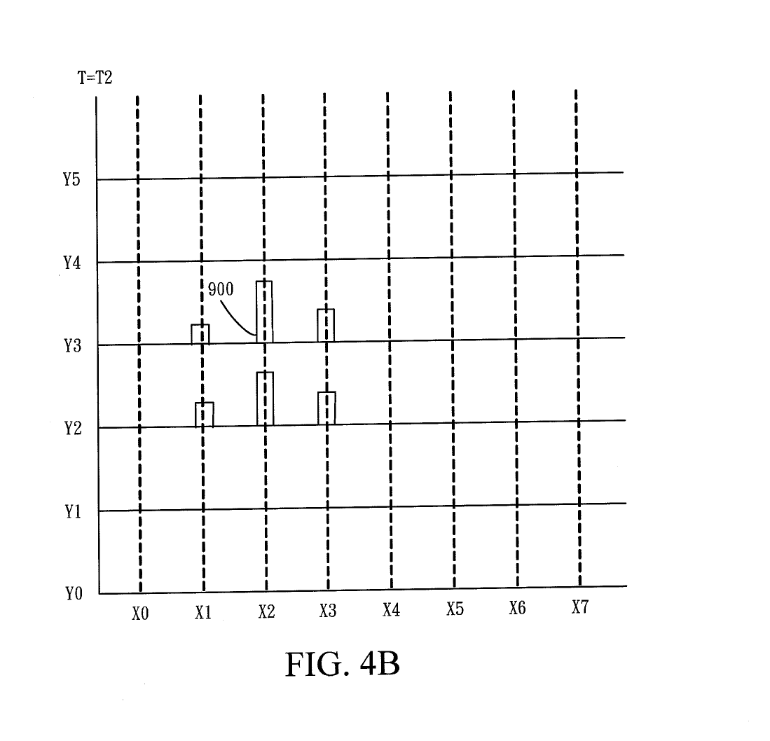

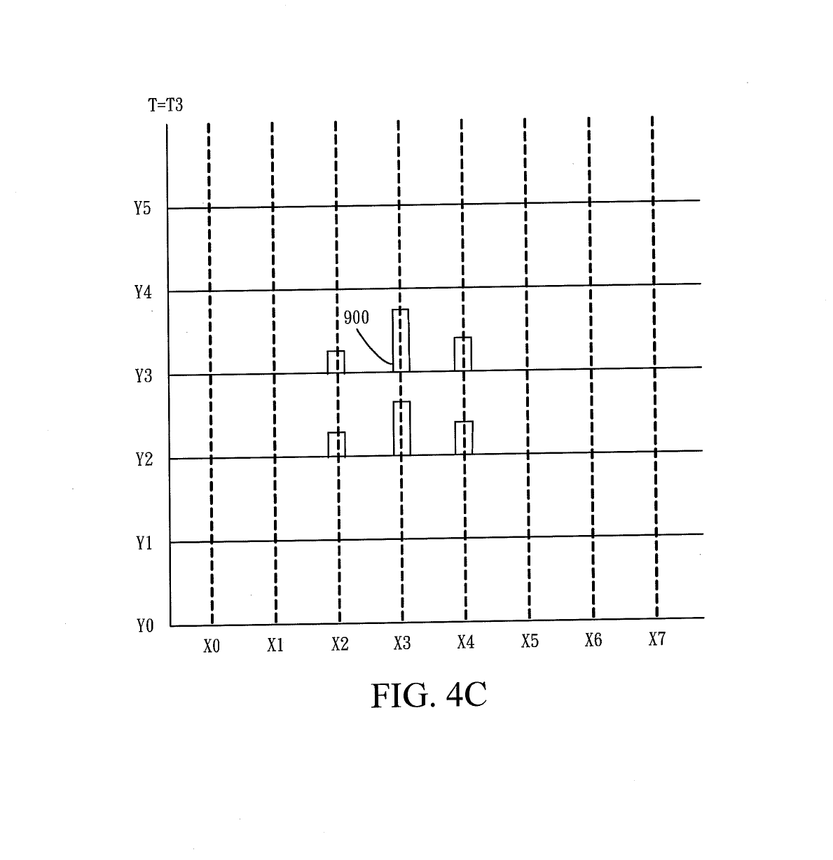

Next, please refer to FIG. 4A to FIG. 4C, which are schematic diagrams of change of an inductance generated when a finger gets close to the key area 531 and performs a key pressing operation. FIG. 4A shows distribution of a capacitive inductance 900 generated when the finger gets close to the Y-axis sensing electrode and the X-axis sensing electrode at the time t=t1. FIG. 4B is a distribution diagram of the capacitive inductance 900 generated when the finger gets close to the Y-axis sensing electrode and the X-axis sensing electrode at the time t=t2. FIG. 4C is a distribution diagram of the capacitive inductance generated by the Y-axis sensing electrode and the X-axis sensing electrode at the time t=t3. In the present invention, the changes of different proximity sensing signals are used to judge whether the coordinate is a hover coordinate or a touch coordinate. The judgment is made based on the proximity detection circuit 470 calculating at least one hover coordinate when the proximity sensing signal of the proximity sensing unit is greater than a hover threshold; and calculating at least one touch coordinate when the proximity sensing signal of the proximity sensing unit is greater than a touch threshold. In FIG. 4B, the hover coordinate is calculated and obtained, while in FIG. 4C, the touch coordinate is calculated and obtained. It can be obtained from FIG. 4A to FIG. 4C that the coordinate of the key area 531 is converted from the hover coordinate to the touch coordinate. Such a change result can be provided to the foregoing two control manners for use.

There are multiple switching methods for switching between the proximity detection mode and the key detection mode, which are respectively illustrated below.

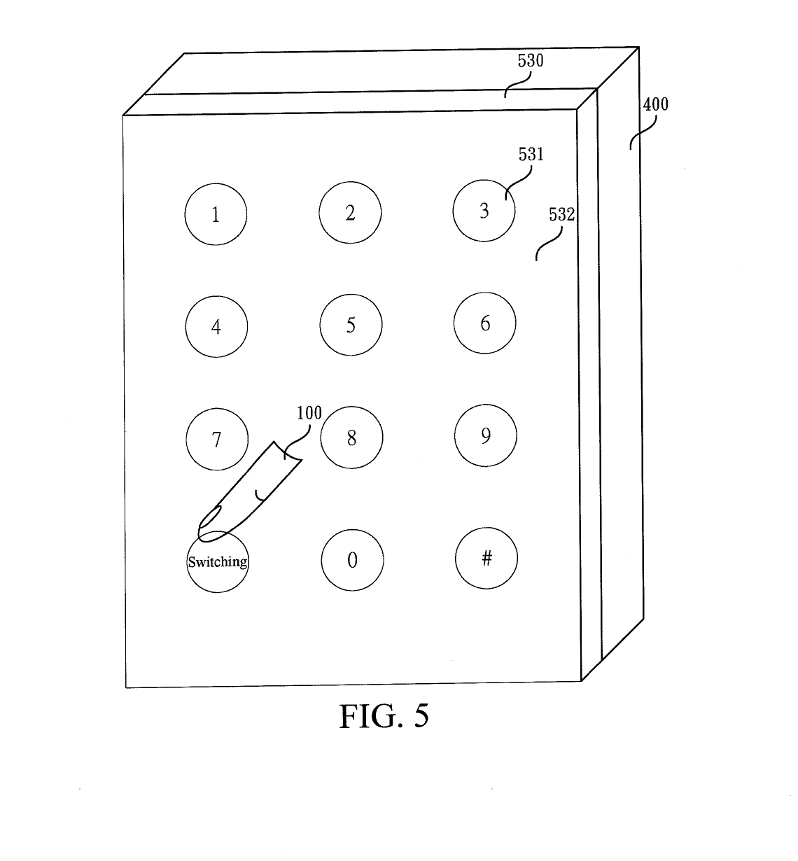

Please refer to FIG. 5, in which a specific “virtual key” is adopted as the switching method. That is, when the mode is switched from the proximity detection mode to the key detection mode, a user must touch a switching key in FIG. 5 for click or double-click with a finger 100, namely, perform selection through a gesture. When the key detection mode is entered, an operation can be performed on the keys at the key area 531. At this time, when judging that the proximity sensing signal of the proximity sensing unit at the key area 531 is greater than the touch threshold, the main control unit 480 can judge that the user operates a key and then can output a corresponding key value according to the coordinate corresponding to the key area 531. For example, when the key 1 is pressed a value of 1 is output. Similarly, when the key 0 is pressed, a value of 0 is output. Coded values of the keys have a specific coding manner, for example, ASCII.

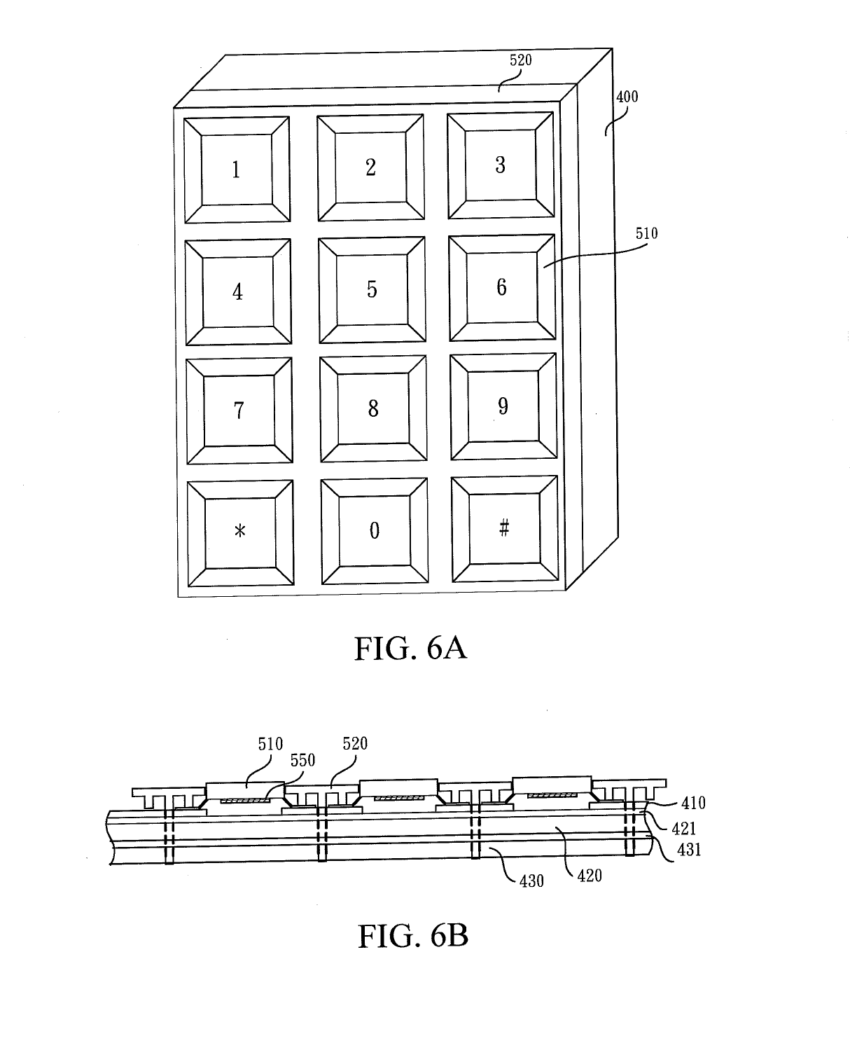

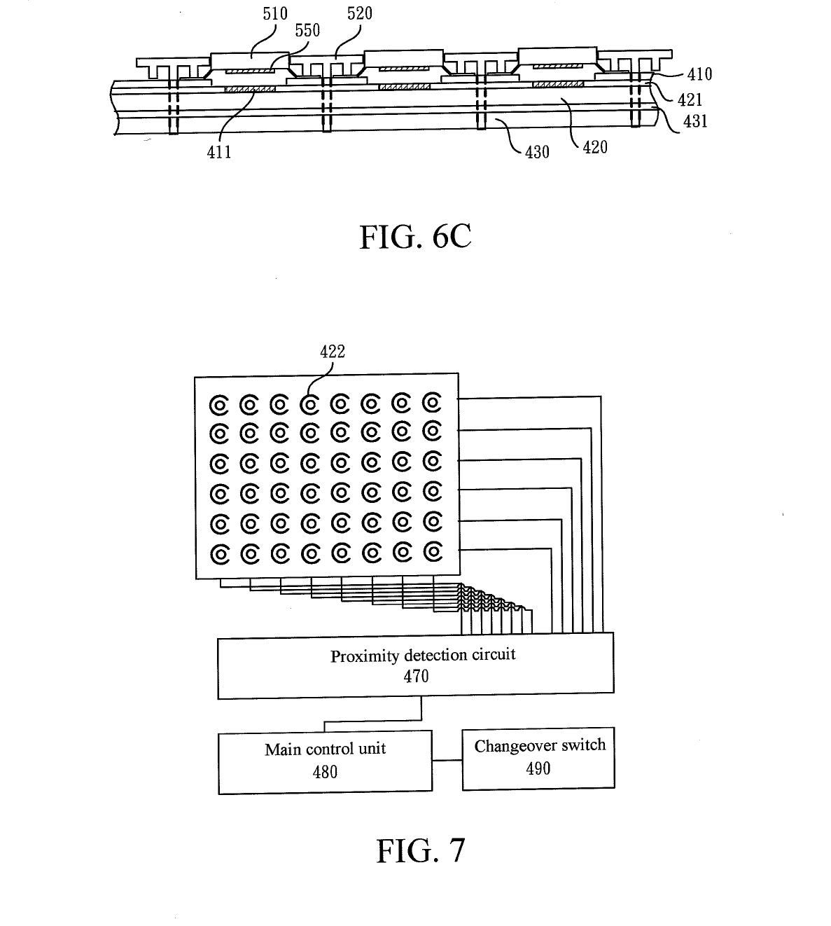

In addition to the form of a film key, a form of a real keyboard may also be used in the present invention. Please refer to FIG. 6A, which is a front view of a second embodiment of the proximity sensing device with a keyboard function according to the present invention, and FIG. 6B, a sectional view of the second embodiment of the proximity sensing device with a keyboard function. In FIG. 6B, the second sensing axis 431 is formed on the substrate 430, the first sensing axis 421 is formed on the substrate 420, and an insulating layer 410 is arranged on the substrate. Conductive rubber 550 is disposed right below a key 510. A space is provided between the conductive rubber 550 and the corresponding insulating layer 410, so that the key 510 can be pressed.

Next, please refer to FIG. 6C, in which a conductive area 411 may be arranged on the key area 531 in the form of a real keyboard, corresponding to the conductive rubber 550; that is, at the part of the insulating layer 410. The conductive area may enable conduction of the conductive rubber 550 and the first sensing axis 421, thereby increasing the inductance of the first sensing axis 421.

Next, please refer to FIG. 7, in which an embodiment of a capacitive proximity sensing unit of a unit-type is shown. A mutual-capacitance proximity sensing unit 422 is formed on the substrate, and is used to sense proximity of an object and generate a sensing signal. The mutual-capacitance proximity sensing unit 422 is in the shape of a concentric circle, a demilune concentric circle, a concentric square, or a concentric square in the shape of the Chinese character “hui” (double squares with one inside the other). In FIG. 7, the mutual-capacitance proximity sensing unit 422 is in the shape of a demilune concentric circle, in which an arc electrode encircles a circular electrode.

While the present invention has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A proximity sensing device with a keyboard function, comprising:
a substrate;
a plurality of proximity sensing units, formed on the substrate, for sensing proximity of at least one object and each generating a proximity sensing signal;
a proximity detection circuit, connected to the proximity sensing unit, for detecting the proximity sensing signal generated for the at least one object and calculating at least one output signal according to the proximity sensing signal;
a key unit, covering the substrate and having a plurality of key areas; and
a main control unit, connected to the proximity detection circuit, for receiving the at least one output signal output by the proximity detection circuit; when the output signal is one of coordinates corresponding to the key areas and is greater than a set key value, outputting a corresponding key value according to the coordinate corresponding to the key area; and when the output signal is greater than a set touch value, converting the output signal and outputting a touch coordinate.

2. The proximity sensing device with a keyboard function according to claim 1, wherein the key unit is a structure with an irregular surface, the substrate is a flexible board, and the flexible board is disposed corresponding to the irregular surface of the key unit, so that a spacing between the key unit and the flexible board is fixed.

3. The proximity sensing device with a keyboard function according to claim 1, wherein each of the proximity sensing units comprises at least two electrodes.

4. The proximity sensing device with a keyboard function according to claim 1, wherein the proximity sensing units are formed by a plurality of first sensing axes and a plurality of second sensing axes formed on different layers of the substrate.

5. The proximity sensing device with a keyboard function according to claim 1, wherein the key area is arranged at an intersection of the first sensing axis and the second sensing axis.

6. The proximity sensing device with a keyboard function according to claim 1, further comprising:
an insulating layer, formed on the first sensing axes.

7. The proximity sensing device with a keyboard function according to claim 6, wherein a conductive area is arranged at each part of the insulating layer corresponding to each of the key areas.

8. The proximity sensing device with a keyboard function according to claim 1, wherein the proximity sensing units are formed by a plurality of first sensing axes formed on the substrate and a plurality of second sensing axes arranged below the substrate.

9. A proximity sensing device with a keyboard function, comprising:
a substrate;
a plurality of proximity sensing units, formed on the substrate, for sensing proximity of at least one object and each generating a proximity sensing signal;
a proximity detection circuit, connected to the proximity sensing unit, for detecting the proximity sensing signal generated for the at least one object and calculating at least one output signal according to the proximity sensing signal;
a key unit, covering the substrate and having a plurality of key areas; and
a main control unit, connected to the proximity detection circuit, for receiving the at least one output signal output by the proximity detection circuit and switching to a proximity detection mode or a key detection mode according to a switching instruction; in the proximity detection mode, when the output signal is greater than a set touch value or a set hover value, converting the output signal and outputting a touch coordinate or a hover coordinate; and in the key detection mode, when the output signal is one of coordinates corresponding to the key areas and is greater than a set key value, outputting a corresponding key value according to the coordinate corresponding to the key area.

10. The proximity sensing device with a keyboard function according to claim 9, wherein the key unit is a structure with an irregular surface, the substrate is a flexible board, and the flexible board is disposed corresponding to the irregular surface of the key unit, so that a spacing between the key unit and the flexible board is fixed.

11. The proximity sensing device with a keyboard function according to claim 9, wherein each of the proximity sensing units comprises at least two electrodes.

12. The proximity sensing device with a keyboard function according to claim 9, wherein the proximity sensing units are formed by a plurality of first sensing axes and a plurality of second sensing axes formed on different layers of the substrate.

13. The proximity sensing device with a keyboard function according to claim 9, wherein the key area is arranged at an intersection of the first sensing axis and the second sensing axis.

14. The proximity sensing device with a keyboard function according to claim 9, further comprising:
an insulating layer, formed on the first sensing axes.

15. The proximity sensing device with a keyboard function according to claim 14, wherein a conductive area is arranged at each part of the insulating layer corresponding to each of the key areas.

16. The proximity sensing device with a keyboard function according to claim 9 wherein the proximity sensing units are formed by a plurality of first sensing axes formed on the substrate and a plurality of second sensing axes arranged below the substrate.

17. The proximity sensing device with a keyboard function according to claim 9, wherein the switching instruction is formed by the main control unit according to a change of the output signal.

18. The proximity sensing device with a keyboard function according to claim 9, wherein the switching instruction is a proximity gesture, and the proximity gesture is obtained through calculation by the main control unit according to a change of the hover coordinate or the touch coordinate.

19. The proximity sensing device with a keyboard function according to claim 18, wherein the proximity gesture is double-click or drawing.

20. The proximity sensing device with a keyboard function according to claim 9, wherein the switching instruction is generated by a changeover switch or generated when one of the key areas is operated.
